(19) United States
(12) Patent Application Publication
(10) Pub. No.: US 2026/0162398 A1
(43) Pub. Date: Jun. 11, 2026

(54) IMAGE SPATIAL NORMALIZATION AND NORMALIZATION SYSTEM AND METHOD USING SAME

(71) Applicant: BRIGHTONIX IMAGING INC., Seoul (KR)

(72) Inventor: Seung Kwan KANG, Seoul (KR)

(21) Appl. No.: 18/708,097

(22) PCT Filed: May 24, 2023
(86) PCT No.: PCT/KR2023/007049

§ 371 Date: May 7, 2024

(30) Foreign Application Priority Data
Jun. 3, 2022 (KR) 10-2022-0068240

(51) Int. Cl. G06V 10/32

(52) U.S. Cl. CPC G06V 10/32

(57) ABSTRACT

The present invention provides image spatial normalization and a normalization system and method using same. Provided are the image spatial normalization performed by a management server and the normalization method using same, the method comprising the steps of: receiving input image data; extracting a deformation field corresponding to the input image data on the basis of a deformation field generator; generating normalization data obtained by performing spatial normalization on the input image data by generating forward deformation data for the input image data by using the deformation field; and generating the deformation field generator trained by repeatedly learning the input image data, wherein the step for generating of the normalization data may comprise a step for automatically generating the normalization data by performing the spatial normalization by using the input image data on the basis of the trained deformation field generator corresponding to the input image data.

### TECHNICAL FIELD

The present invention relates to a normalization system and method employing image spatial normalization.

### BACKGROUND ART

For statistical analysis of medical images, it is reasonable to normalize images obtained from individual subjects to a single space and compare the normalized images as three-dimensional (3D) pixel values.

In particular, spatial normalization is an essential procedure for statistical comparison or objective evaluation of brain positron emission tomography (PET) and single-photon emission computed tomography (SPECT) images.

When spatial normalization is performed using only brain PET images, many errors occur.

Specifically, it is difficult to perform spatial normalization for PET, SPECT, functional magnetic resonance imaging (fMRI), electroencephalography (EEG), magnetoencephalography (MEG), and the like using sole information due to the characteristic of functional images and limited spatial resolutions.

Therefore, in general, MRI or computed tomography (CT) images are also captured and spatially normalized first, and then an obtained deformation vector field (or deformation field) is applied to the functional images for spatial normalization.

This method has the advantage of obtaining accurate data but requires high cost for expensive equipment, which may be time-consuming and costly.

In addition, there is a method of spatially normalizing brain PET images using an average template obtained from various samples. However, this does not accurately reflect various characteristics of images of patients, normal people, and the like and thus makes accurate analysis difficult.

Meanwhile, researchers have lately been using machine learning, which is deep learning based on big data, to successfully solve complex and high-dimensional problems in many fields.

Accordingly, it is necessary to develop a technology for performing accurate spatial normalization at a low cost using such a machine learning technique and the like without performing MRI or CT.

The above description of background art is only for the purpose of facilitating understanding of the background of the present invention and should not be construed as prior art that is well known to those skilled in the technical field.

### DISCLOSURE

### Technical Problem

The present invention is directed to providing a quantification system and method employing image spatial normalization.

Objects of the present invention are not limited to that described above, and other objects which have not been described will be clearly understood by those of ordinary skill in the art from the following description.

### Technical Solution

One aspect of the present invention provides a quantification method employing image spatial normalization and performed by a management server according to an exemplary embodiment, the quantification method including receiving input image data, extracting a deformation field corresponding to the input image data on the basis of a deformation field generator, generating forward deformation data for the input image data using the deformation field and generating normalization data by spatially normalizing the input image data, and generating the deformation field generator trained by repeatedly performing training with the input image data. The generating of the normalization data includes performing spatial normalization using the input image data on the basis of the trained deformation field generator corresponding to the input image data to automatically generate the normalization data.

According to the exemplary embodiment of the present invention, the deformation field generator may be repeatedly trained with the input image data and other-modality image data matching the input image data.

According to the exemplary embodiment of the present invention, the generating of the deformation field generator may include spatially normalizing the other-modality image data using the deformation field to generate deformed other-modality image data, calculating an error value for maximizing a similarity value between the deformed other-modality image data and template data corresponding to the deformed other-modality image data, and repeatedly training the deformation field generator to minimize the error value.

According to the exemplary embodiment of the present invention, the generating of the normalization data may include repeatedly performing a process of generating at least one piece of forward deformation data for the input image data using at least one deformation field on the basis of at least one deformation field generator and generating the normalization data by spatially normalizing the input image data. The generating of the normalization data may include extracting a first deformation field corresponding to the input image data on the basis of a first deformation field generator, generating first forward deformation data for the input image data using the first deformation field, spatially normalizing the input image data using the first forward deformation data to generate spatially normalized first deformation input image data, extracting a second deformation field corresponding to the first deformation input image data on the basis of a second deformation field generator, and generating second forward deformation data for the first deformation input image data using the second deformation field to generate the spatially normalized normalization data.

According to the exemplary embodiment of the present invention, the quantification method may further include generating a backward deformation field for the template data using the deformation field, applying the backward deformation field to the template data to perform backward spatial normalization, comparing an image subjected to the backward spatial normalization with the input image data or the other-modality image data, and repeatedly training the deformation field generator with the image subjected to the backward spatial normalization.

According to the exemplary embodiment of the present invention, the quantification method may further include extracting a quantification value using the normalization data for quantification.

Another aspect of the present invention provides a quantification system employing image spatial normalization according to an exemplary embodiment, the quantification system including an imaging apparatus configured to acquire input image data and other-modality image data matching the input image data and a management server configured to extract a deformation field corresponding to the input image data on the basis of a deformation field generator, generate forward deformation data for the input image data using the deformation field, and generate normalization data by spatially normalizing the input image data. The management server repeatedly performs training with the input image data to generate the trained deformation field generator and automatically generates the normalization data by performing spatial normalization using the input image data on the basis of the trained deformation field generator corresponding to the input image data.

Still another aspect of the present invention provides a program stored in a computer-readable recording medium according to an exemplary embodiment to perform the quantification method employing image spatial normalization in combination with a computer which is hardware.

Other details of the present invention are included in the detailed description and drawings.

### Advantageous Effects

According to the present invention, it is possible to automatically perform spatial normalization using individual-, business-, and company-specific images corresponding to healthcare, finance, construction, insurance, law, education, public services, culture, and the like.

According to the present invention, it is possible to automatically perform spatial normalization on the basis of a deformation field which is extracted using medical images mainly containing functional information without medical images containing anatomical information.

According to the present invention, a deformation field generator is repeatedly trained using medical images mainly containing functional information and medical images which match the medical images mainly containing functional information and mainly contain anatomical information together, and then the medical images mainly containing functional information are automatically spatially normalized using only the medical images. Accordingly, medical images containing individual-specific functional information can be spatially normalized to accurately reflect various features thereof.

According to the present invention, only medical images mainly containing functional information are used for automatic quantification. Accordingly, it is possible to minimize errors and obtain an imagery interpretation result with high accuracy.

According to the present invention, it is possible to clearly determine a disease stage using each individual's image and reduce medical costs through diagnosis automation.

According to the present invention, it is possible to apply automatically spatially normalized images to various analyzable fields for quantification.

According to the present invention, it is possible to detect various diseases at their early stages using automatically spatially normalized images. Accordingly, it is possible to improve access to medical and support services and provide opportunities for financial and care planning.

Effects of the present invention are not limited to those described above, and other effects which have not been described will be clearly understood by those of ordinary skill in the art from the following description.

### [DESCRIPTION OF DRAWINGS]

FIG. 1 is a conceptual diagram illustrating a quantification system employing image spatial normalization according to an embodiment of the present invention.

FIG. 2 is a diagram illustrating a detailed configuration of the quantification system employing image spatial normalization shown in FIG. 1.

FIG. 3 is a flowchart illustrating a training method using a quantification method employing image spatial normalization and a deformation field generator according to an embodiment of the present invention.

FIG. 4 is a diagram illustrating the concept of generating spatially normalized normalization data in FIG. 3 according to an embodiment of the present invention.

FIG. 5 is a diagram illustrating the concept of generating spatially normalized normalization data in FIG. 3 according to another embodiment of the present invention.

FIG. 6 is a diagram illustrating the concept of generating a trained deformation field generator in FIG. 3 according to an embodiment of the present invention.

FIGS. 7 and 8 are diagrams illustrating an embodiment of the present invention and a comparative example.

### MODES OF THE INVENTION

Advantages and features of the present invention and methods of achieving the same will become apparent with reference to embodiments that are described in detail in conjunction with the accompanying drawings. However, the present invention is not limited to the embodiments set forth herein and can be implemented in various different forms. The embodiments are provided only to make the disclosure of the present invention complete and fully convey the scope of the present invention to those of ordinary skill in the technical field to which the present invention pertains. The present invention is defined only by the category of the claims.

Terminology used herein is for the purpose of describing embodiments and is not intended to be limiting of the present invention. As used herein, the singular forms are intended to include the plural forms as well, unless the context clearly indicates otherwise. The terms “comprises” and/or “comprising” used herein do not preclude the presence or addition of one or more components other than listed components. Throughout the specification, like reference numerals refer to like components, and the term “and/or” includes any and all combinations of listed items. Although terms including “first,” “second,” and the like are used for describing various components, the components are not limited by the terms. These terms are merely used for distinguishing one component from another. Therefore, in the following description, a first component may be a second component within the technical spirit of the present invention.

Unless otherwise defined, all terms (including technical and scientific terms) used herein have the same meaning as commonly understood by those skilled in the technical field to which present invention pertains. Also, terms defined in commonly used dictionaries are not interpreted in an idealized or overly formal sense unless expressly so defined herein.

Hereinafter, embodiments of the present invention will be described in detail with reference to the accompanying drawings.

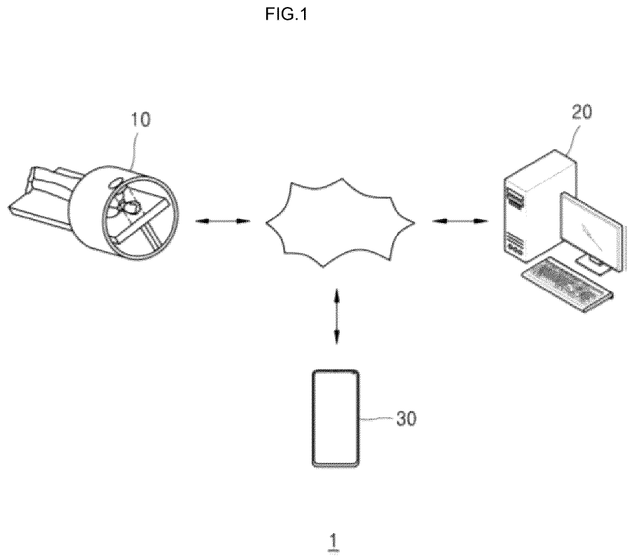

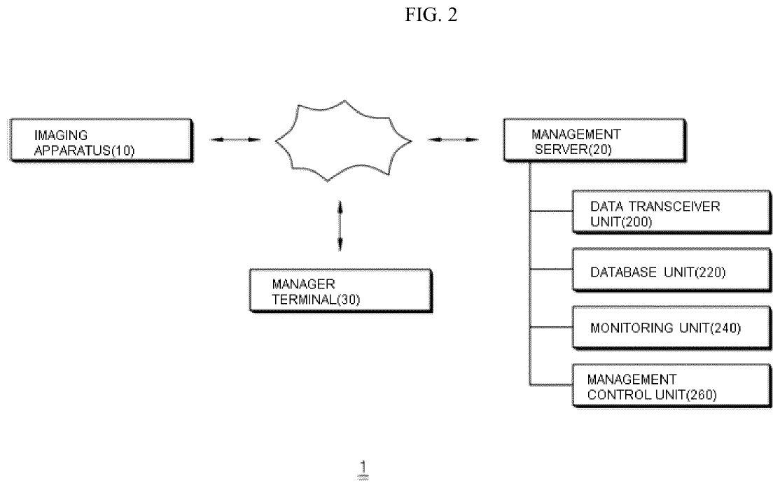

FIG. 1 is a conceptual diagram illustrating a quantification system employing image spatial normalization according to an embodiment of the present invention, and FIG. 2 is a diagram illustrating a detailed configuration of the quantification system employing image spatial normalization shown in FIG. 1.

As shown in FIGS. 1 and 2, a quantification system 1 employing image spatial normalization according to an embodiment of the present invention may include an imaging apparatus 10, a management server 20, and a manager terminal 30. Here, the manager terminal 30 may be omitted.

The imaging apparatus 10, the management server 20, and the manager terminal 30 may be synchronized in real time through a wireless communication network to transmit and receive data. The wireless communication network may support various long-distance communication methods. For example, various communication methods including a wireless local area network (WLAN), Digital Living Network Alliance (DLNA), wireless broadband (WiBro), World Interoperability for Microwave Access (WiMAX), Global System for Mobile communication (GSM), code division multiple access (CDMA), CDMA2000, Enhanced Voice-Data Optimized or Enhanced Voice-Data Only (EV-DO), Wideband CDMA (WCDMA), High Speed Downlink Packet Access (HSDPA), High-Speed Uplink Packet Access (HSUPA), Institute of Electrical and Electronics Engineers (IEEE) 802.16, Long Term Evolution (LTE), LTE-Advanced (LTEA), Wireless Mobile Broadband Service (WMBS), Bluetooth Low Energy (BLE), ZigBee, radio frequency (RF), Long Range (LoRa), and the like may be applied. However, the communication methods are not limited thereto, and a variety of widely known wireless communication or mobile communication methods may be applied.

The imaging apparatus 10 may be an apparatus that may acquire input image data, such as medical image data, containing functional information by imaging a brain state of a patient. In other words, the imaging apparatus 10 may acquire a positron emission tomography (PET) image of beta-amyloid existing in the patient's brain by imaging the brain of the patient who has radiotracers injected into his or her body. Here, the medical image data containing functional information may be, but is not limited to, any functional medical image that is difficult to spatially normalize using sole information such as single-photon emission computed tomography (SPECT), functional magnetic resonance imaging (fMRI), electroencephalography (EEG), magnetoencephalography (MEG), and the like.

For example, the input image data may include not only medical image data but also individual-, business-, and company-specific image data corresponding to finance, construction, insurance, law, education, public services, culture, and the like.

The imaging apparatus 10 is, but is not limited to, PET equipment, SPECT equipment, and the like, which may acquire functional image data about the distribution of radiotracers in a patient's brain by imaging the brain of the patient who has radiotracers injected into his or her body, and computed tomography (CT) equipment, MRI equipment, near-infrared spatially resolved spectroscopy (NIRS) equipment, and the like.

Specifically, the imaging apparatus 10 includes at least one of a flash camera, a gamma camera, and a PET/CT scanner, and may image at least one part of the patient's brain among the frontal cortex, the posterior cingulate gyrus, the lateral temporal lobe, the parietal lobe, the occipital cortex, the caudate nucleus, the medial temporal lobe, and the anterior cingulate gyrus. Here, the radiotracers are a material that is injected into the patient's body and binds to beta-amyloid plaques, which are reported to cause Alzheimer's disease, to visualize beta amyloid in the patient's brain in a PET image. The type of radiotracers may include at least one radioactive isotope among F-18, C-11, N-13, and O-15, but is not limited thereto.

According to an embodiment, the imaging apparatus 10 may acquire other-modality image data such as MRI image data or CT image data, that is, a different type of medical image data containing anatomical information, but image data acquired by the imaging apparatus 10 is not limited thereto. Here, the other-modality image data may be data matching the input image data, but is not limited thereto.

In the present embodiment, image data is acquired through the imaging apparatus 10, but image data is not limited thereto and may be that recorded in institutions such as companies, courts, hospitals, and the like.

The management server 20 may include a data communication unit 200, a database unit 220, a monitoring unit 240, and a management control unit 260.

The communication unit 200 may receive input image data and other-modality image data matching the input image data.

According to an embodiment, the communication unit 200 may transmit the input image data and the other-modality image data to the manager terminal 30 and receive normalization data from the manager terminal 30.

The database unit 220 may store data transmitted to or received from the imaging apparatus 10, the management server 20, or the manager terminal 30 through the wireless communication network.

The database unit 220 may store data that supports various functions of the management server 20. In other words, the database unit 220 may store multiple application programs (or applications) run by the management server 20 and data and instructions for operations of the management server 20. At least some of the application programs may be downloaded from an external server through wireless communication.

Meanwhile, data which is stored in the database unit 220 and used in the present embodiment may be provided in the form of a mapping table in which pieces of data correspond to each other, but is not limited thereto.

The monitoring unit 240 may allow monitoring of an operation state of the imaging apparatus 10, the management server 20, or the manager terminal 30, data transmitted and received between the imaging apparatus 10, the management server 20, and the manager terminal 30, and the like through a screen.

When the input image data is received from the imaging apparatus 10, the management control unit 260 may generate normalization data by automatically performing spatial normalization using only the input image data.

Specifically, when the input image data is received, the management control unit 260 may extract a deformation field corresponding to the input image data on the basis of a deformation field generator, generate forward deformation data for the input image data using the extracted deformation field, and generate normalization data by spatially normalizing the input image data.

In other words, the management control unit 260 may receive the input image data and extract a deformation field of the input image data to spatially normalize the input image data. Here, the input image data may be automatically preprocessed for shaking, color bleeding, ambient noise, and the like and may be images or a video when duplicate data may be deleted from the input image data.

The deformation field may be extracted according to a value of a vector field in which each pixel included in the input image data is movable in three-dimensional (3D) directions on the basis of x, y, and z axes for spatial normalization according to template data.

For example, the management control unit 260 may extract the deformation field according to the template data from the preprocessed input image data and generate forward deformation data for the input image data.

Also, the management control unit 260 may generate the template data for spatially normalizing the input image data.

For example, when a plurality of pieces of input image data are received, the management control unit 260 may input the input image data to a deep learning architecture and generate spatially normalized data to which the deformation field generator trained through deep learning is applied. The deep learning architecture includes a convolutional neural network (CNN) and may be an artificial neural network that understands input images through computation and extracts features to acquire information or generate new images.

In addition, when the input image data is received, the management control unit 260 may extract the deformation field corresponding to the input image data on the basis of the deformation field generator, generate forward deformation data for the input image data using the extracted deformation field, generate a backward deformation field for the input image data using the template data, and then generate the normalization data by spatially normalizing the input images using the generated forward deformation data.

In other words, the management control unit 260 may generate a backward deformation field for the template data using the deformation field.

Specifically, the management control unit 260 may generate the backward deformation field for the input image data by applying the template data to the deformation field to increase the accuracy of the input image data and the template data.

For example, the management control unit 260 may generate the backward deformation field for the template data using the deformation field, perform backward spatial normalization by applying the generated backward deformation field to the template data, and then compare the images subjected to backward spatial normalization with the input image data or the other-modality image data. Here, the management control unit 260 may repeatedly train the deformation field generator with the images subjected to backward spatial normalization.

According to an embodiment, the management control unit 260 may generate the backward deformation field for the input image data by applying the forward deformation data to the deformation field.

Also, the management control unit 260 may generate normalization data having continuity using only the input image data.

Specifically, the management control unit 260 may repeatedly spatially normalize the input image data by applying the input image data to a plurality of deformation field generators, generating accurate normalization data.

For example, when the input image data is received, the management control unit 260 may extract a first deformation field corresponding to the input image data on the basis of a first deformation field generator, generate first forward deformation data for the input image data using the extracted first deformation field, generate spatially normalized first deformation input image data by spatially normalizing the generated first forward deformation data, extract a second deformation field corresponding to the first deformation input image data on the basis of a second deformation field generator, generate second forward deformation data for the first deformation input image data using the extracted second deformation field, generate spatially normalized second deformation input image data by spatially normalizing the generated second forward deformation data, extract a third deformation field corresponding to the second deformation input image data on the basis of a third deformation field generator, generate third forward deformation data for the second deformation input image data using the extracted third deformation field, and generate spatially normalized final normalization data using the generated third forward deformation data.

In the present embodiment, final normalization data is generated on the basis of first to third deformation field generators. However, the present invention is not limited thereto, and normalization data may be generated on the basis of at least a first deformation field generator.

Also, the management control unit 260 may generate a trained deformation field generator by repeatedly training a deformation field generator using input image data and other-modality image data matching the input image data. Here, the management control unit 260 may train the deformation field generator using a deep learning or machine learning technique, but the method of training a deformation field generator is not limited thereto.

Specifically, the management control unit 260 may generate deformed other-modality image data by spatially normalizing the other-modality image data using the deformation field and then calculate an error value for maximizing a similarity value between the deformed other-modality image data and template data corresponding to the deformed other-modality image data. A trained deformation field generator may be generated by repeatedly training a deformation field generator to minimize the calculated error value.

In other words, the management control unit 260 may generate spatially normalized deformation input image data on the basis of the input image data, determine the authenticity of the deformation input image data by calculating an error value between deformed other-modality image data, which is spatially normalized on the basis of other-modality image data paired with the input image data, and template data corresponding to the deformed other-modality image data, and generate normalization data. In other words, the management control unit 260 repeatedly performs training using input image data containing functional information and other-modality image data containing anatomical information matching the input image data and thus can automatically perform spatial normalization using only medical images containing functional information.

For example, the management control unit 260 may calculate an error value for maximizing a cross correlation value between MRI deformation data and MRI template data. In other words, a deformation field generator may be repeatedly trained to minimize the calculated error value.

Also, the management control unit 260 may automatically generate normalization data by spatially normalizing forward deformation data on the basis of the trained deformation field generator.

According to an embodiment, the management control unit 260 may repeatedly train a CNN algorithm using input image data and normalization data matching the input image data and verify appropriateness.

Also, the management control unit 260 may extract a quantification value of a specific field from normalization data for quantification. When only input image data is given, the management server 20 with this structure can perform spatial normalization using a deformation field, which is extracted according to the input image data on the basis of a deformation field generator trained to have a minimum error value by comparing spatially normalized data of other-modality image data corresponding to input image data with template data, to generate spatially normalized normalization data.

The management server 20 may be implemented as a hardware circuit (e.g., a complementary metal oxide semiconductor (CMOS)-based logic circuit), firmware, software, or a combination thereof. For example, the management server 20 may be implemented in various forms of electrical structures using transistors, logic gates, and electronic circuits.

The manager terminal 30 is a terminal carried by a manager and may be synchronized with the imaging apparatus 10 and the management server 20 in real time through the wireless communication network to transmit and receive data. Here, the manager terminal 30 may transmit and receive data using an application program (or application).

The manager terminal 30 may automatically quantify an input image by spatially normalizing input image data received from the imaging apparatus 10 and/or the management server 20.

The manager terminal 30 may be any of various portable electronic communication devices that support communication with the imaging apparatus 10 and the management server 20. For example, as a smart device, the imaging apparatus 10 may be any of a variety of portable terminals, such as a smartphone, a personal digital assistant (PDA), a tablet, a wearable device, a smartwatch, smart glasses, a head mounted display (HMD), and various Internet of things (IoT) terminals. Alternatively, the imaging apparatus 10 may be a non-portable electronic communication device such as a desktop computer, a workstation computer, or the like.

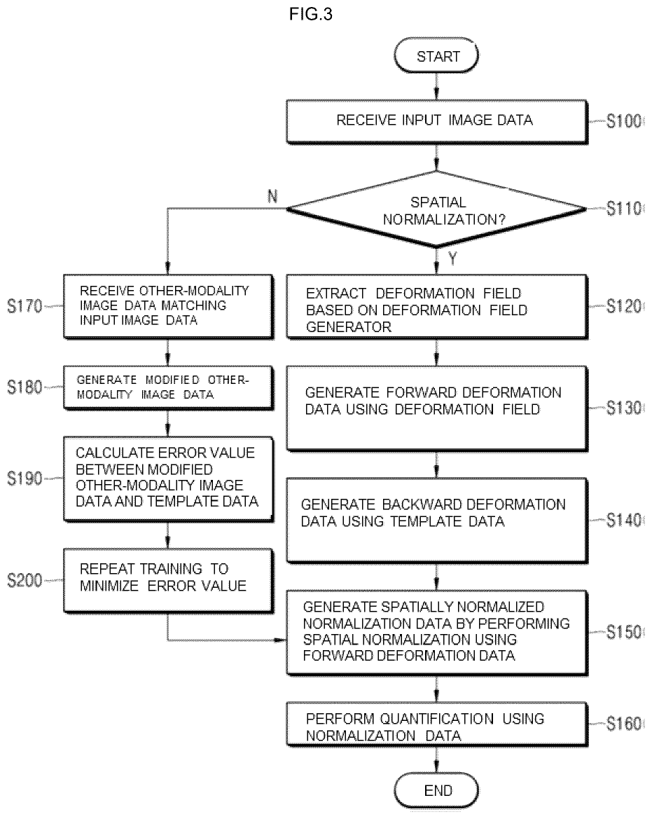

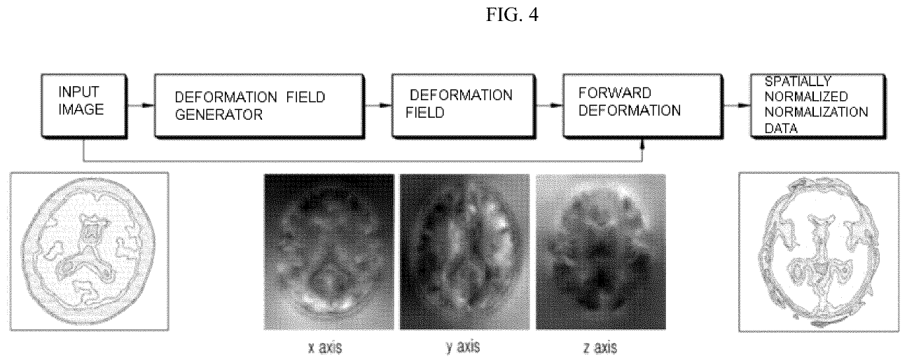

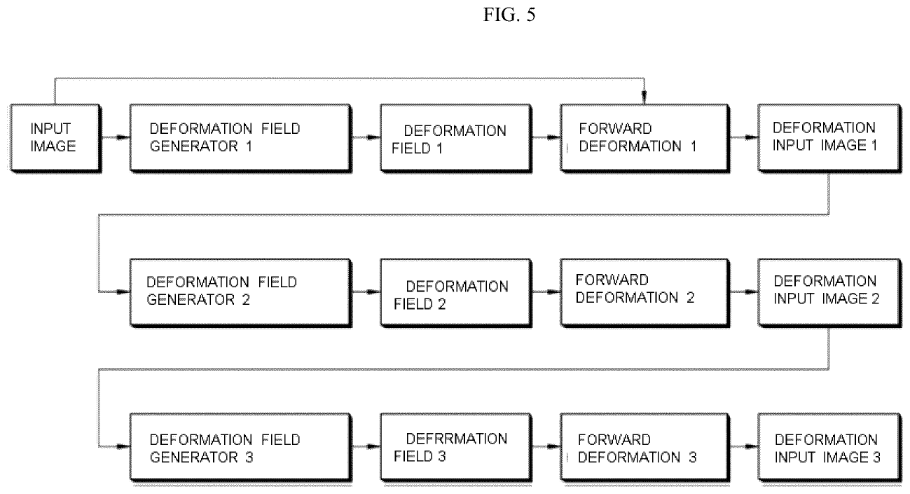

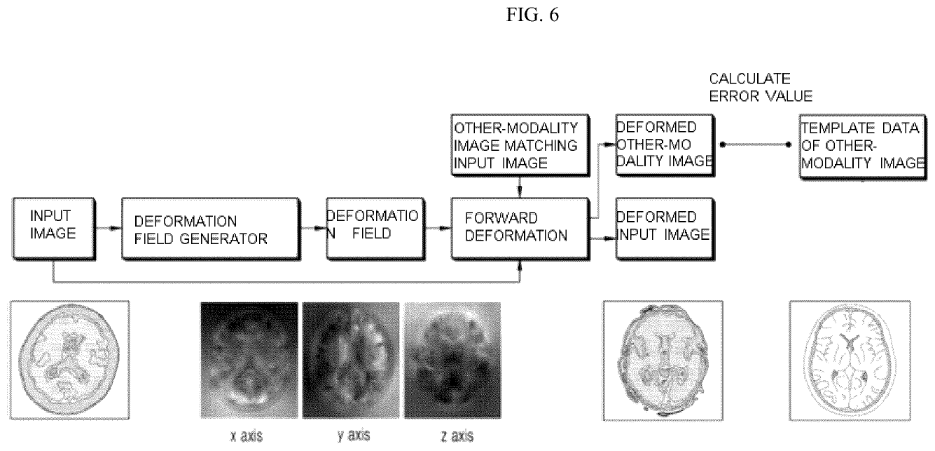

The quantification system employing image spatial normalization with this structure according to the embodiment of the present invention operates as follows. FIG. 3 is a flowchart illustrating a training method using a quantification method employing image spatial normalization and a deformation field generator according to an embodiment of the present invention. FIG. 4 is a diagram illustrating the concept of generating spatially normalized normalization data in FIG. 3 according to an embodiment of the present invention. FIG. 5 is a diagram illustrating the concept of generating spatially normalized normalization data in FIG. 3 according to another embodiment of the present invention. FIG. 6 is a diagram illustrating the concept of generating a trained deformation field generator in FIG. 3 according to an embodiment of the present invention.

First, as shown in FIG. 3, the management server 20 may receive input image data from the imaging apparatus 10 (S100).

The input image data may include not only medical image data containing functional data but also individual-, business-, and company-specific image data corresponding to finance, construction, insurance, law, education, public services, culture, and the like.

Subsequently, the management server 20 may determine whether to perform spatial normalization using the input image data (S110).

When it is determined to perform spatial normalization using only the input image data (S110), the management server 20 may extract a deformation field corresponding to the input image data on the basis of the deformation field generator (S120).

Subsequently, the management server 20 may generate forward deformation data for the input image data using the deformation field (S130).

Subsequently, the management server 20 may generate a backward deformation field using template data (S140).

Subsequently, the management server 20 may generate normalization data by performing spatial normalization using the forward deformation data (S150).

Specifically, referring to FIG. 4, when the input image data is received, the management server 20 may extract a deformation field corresponding to the input image data on the basis of a deformation field generator, generate forward deformation data for the input image data using the extracted deformation field, generate a backward deformation field by applying the deformation field to the template data, and then generate normalization data by spatially normalizing the input image data using the generated forward deformation data.

According to an embodiment, the management server 20 may generate normalization data having continuity.

For example, as shown in FIG. 5, when the input image data is received, the management server 20 may extract a first deformation field corresponding to the input image data on the basis of a first deformation field generator, generate first forward deformation data for the input image data using the extracted first deformation field to generate spatially normalized first deformation input image data, extract a second deformation field corresponding to the first deformation input image data on the basis of a second deformation field generator, generate second forward deformation data for the first deformation input image data using the extracted second deformation field to generate spatially normalized second deformation input image data, extract a third deformation field corresponding to the second deformation input image data on the basis of a third deformation field generator, generate third forward deformation data for the second deformation input image data using the extracted third deformation field, and generate spatially normalized final normalization data using the generated third forward deformation data.

Finally, the management server 20 may perform quantification of extracting a quantification value of a specific region from the normalized data (S160).

Unlike this, when it is not determined to perform spatial normalization using only the input image data (S110), the management server 20 may generate a trained deformation field generator using other-modality image data on the basis of a deep learning technique, a machine learning technique, or the like (S170 to S200).

Specifically, referring to FIG. 6, the management server 20 may receive the input image data and other-modality image data matching the input image data (S170), generate deformed other-modality image data by spatially normalizing the other-modality image data using a deformation field (S180), calculate an error value for maximizing a similarity value between the generated deformed other-modality image data and template data corresponding to the deformed other-modality image data (S190), and repeatedly train the deformation field generator to minimize the error value (S200).

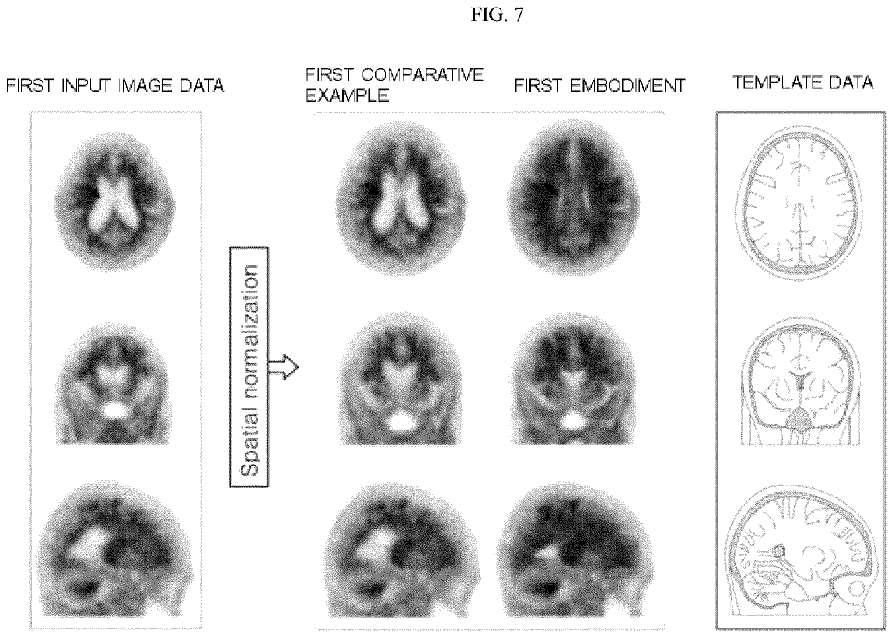

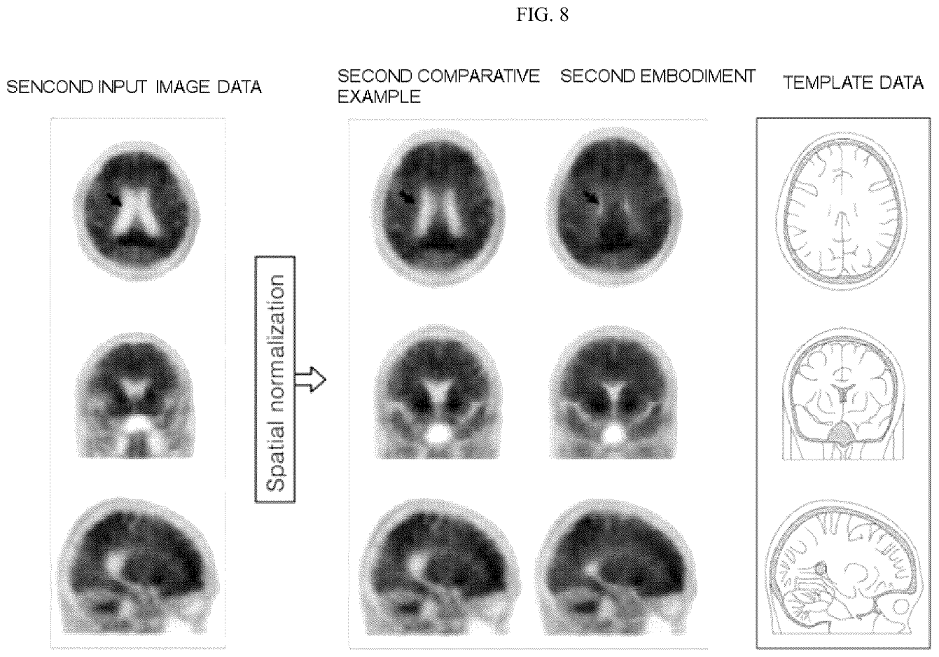

The spatial normalization method employing only input image data and the spatial normalization method employing input image data and other-modality image data matching the input image data according to an embodiment of the present invention will be compared to describe the accuracy of spatial normalization in detail below with reference to FIGS. 7 and 8. FIGS. 7 and 8 are diagrams illustrating an embodiment of the present invention and a comparative example. FIG. 7 shows spatial normalization comparison results between the embodiment and the comparative example when amyloid is negative, and FIG. 8 shows spatial normalization comparison results between the embodiment and the comparative example when amyloid is positive.

First, first and second embodiments shown in FIGS. 7 and 8 may be examples of generating normalization data by performing spatial normalization using only input image data on the basis of a deformation field generator which is trained to have a minimum error value by comparing spatially normalized data of other-modality image data corresponding to the input image data with template data, and first and second comparative examples may be examples of generating normalization data by performing spatial normalization using input image data and other-modality image data corresponding to the input image data. Here, first input image data may be first input medical images mainly containing functional information, that is, input image data of a case with severe brain atrophy and negative amyloid, and second input image data may be first input medical images mainly containing functional information, that is, input image data of a case with severe brain atrophy and positive amyloid.

In the present embodiment, the first and second comparative examples may be, but are not limited to being, generated using the program called Statistical Parametric Mapping 12 (SPM12) and MRI images matching input images.

Specifically, referring to FIG. 7, when spatial normalization is performed using only input image data like in the first embodiment of the case with severe brain atrophy and negative amyloid, spatially normalized data of the embodiment is more accurate than that of the first comparative example. In other words, when spatial normalization is performed using only input image data according to an embodiment of the present invention, it is possible to obtain accurate normalization data.

For example, referring to the embodiments and the comparative examples, the accuracy of spatial normalization may be analyzed by calculating a true value or a gold standard value which is a standard uptake value ratio (SUVR) of a PET image. Here, the true value may be, but is not limited to, a value obtained by subdividing brain regions in an MRI image using the program called FreeSurfer.

In other words, in the first and second comparative examples, spatial normalization can be performed using input image data and other-modality image data corresponding to the input image data, whereas, in the first and second embodiments, only input image data is used on the basis of a trained deformation field generator which compares spatially normalized data of other-modality image data corresponding to input image data with template data to have a minimum error value.

Accordingly, with the spatial normalization method employing the first and second embodiments according to an embodiment of the present invention, it is possible to spatially normalize an input image with accuracy without other-modality image data while minimizing the execution time of the spatial normalization method.

The normalization system and method employing image spatial normalization according to embodiments of the present invention were developed through 2020 biomedical technology commercialization support project (BT200151) “Development of platform for analyzing functional brain image of degenerative brain disease based on AI” of Seoul Business Agency of Seoul city.

Operations of methods or algorithms described in connection with embodiments of the present invention may be directly implemented by hardware, implemented by software modules executed by hardware, or implemented by a combination of hardware and software modules. The software modules may be present on a random-access memory (RAM), a read-only memory (ROM), an erasable programmable ROM (EPROM), an electrically erasable programmable ROM (EEPROM), a flash memory, a hard disk, a removable disk, a compact disc (CD)-ROM, or any type of computer-readable recording medium well known in the technical field to which the present invention pertains.

Although embodiments of the present invention have been described with reference to the accompanying drawings, it will be understood by those skilled in the technical field to which the present disclosure pertains that the present invention may be implemented in other specific forms without departing from the technical spirit or essential features thereof. Therefore, the above-described embodiments should be construed as illustrative rather than restrictive in all aspects.

1. A quantification method employing image spatial normalization and performed by a management server, the method comprising:
receiving input image data;
extracting a deformation field corresponding to the input image data on the basis of a deformation field generator;
generating forward deformation data for the input image data using the deformation field and generating normalization data by spatially normalizing the input image data; and
generating the deformation field generator trained by repeatedly performing training with the input image data,
wherein the generating of the normalization data comprises performing spatial normalization using the input image data on the basis of the trained deformation field generator corresponding to the input image data to automatically generate the normalization data.

2. The quantification method of claim 1, wherein the deformation field generator is repeatedly trained with the input image data and other-modality image data matching the input image data.

3. The quantification method of claim 2, wherein the generating of the deformation field generator comprises:
spatially normalizing the other-modality image data using the deformation field to generate deformed other-modality image data;
calculating an error value for maximizing a similarity value between the deformed other-modality image data and template data corresponding to the deformed other-modality image data; and
repeatedly training the deformation field generator to minimize the error value.

4. The quantification method of claim 1, wherein the generating of the normalization data comprises repeatedly performing a process of generating at least one piece of forward deformation data for the input image data using at least one deformation field on the basis of at least one deformation field generator and generating the normalization data by spatially normalizing the input image data, and
the generating of the normalization data comprises:
extracting a first deformation field corresponding to the input image data on the basis of a first deformation field generator;
generating first forward deformation data for the input image data using the first deformation field;
spatially normalizing the input image data using the first forward deformation data to generate spatially normalized first deformation input image data;
extracting a second deformation field corresponding to the first deformation input image data on the basis of a second deformation field generator; and
generating second forward deformation data for the first deformation input image data using the second deformation field to generate the spatially normalized normalization data.

5. The quantification method of claim 3, further comprising:
generating a backward deformation field for the template data using the deformation field;
applying the backward deformation field to the template data to perform backward spatial normalization;
comparing an image subjected to the backward spatial normalization with the input image data or the other-modality image data; and
repeatedly training the deformation field generator with the image subjected to the backward spatial normalization.

6. The quantification method of claim 1, further comprising extracting a quantification value using the normalization data for quantification.

7. A quantification system employing image spatial normalization, the quantification system comprising:
an imaging apparatus configured to acquire input image data and other-modality image data matching the input image data; and
a management server configured to extract a deformation field corresponding to the input image data on the basis of a deformation field generator, generate forward deformation data for the input image data using the deformation field, and generate normalization data by spatially normalizing the input image data,
wherein the management server repeatedly performs training with the input image data to generate the trained deformation field generator, and
the management server automatically generates the normalization data by performing spatial normalization using the input image data on the basis of the trained deformation field generator corresponding to the input image data.

8. A computer program stored in a computer-readable recording medium to perform the method of claim 1 in combination with a computer which is hardware.
